(19) United States
(12) Patent Application Publication
(10) Pub. No.: US 2008/0282000 A1
(43) Pub. Date: Nov. 13, 2008

(54) INTERFACE CONTROLLER FOR CONTROLLING OPERATION OF EXTERNALLY COUPLED ELECTRONIC APPARATUS

(75) Inventors: Haruo Nishida, Sapporo-shi (JP); Kazunori Kojima, Sapporo-shi (JP); Ryuichi Kagaya, Sapporo-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/117,277

(22) Filed: May 8, 2008

(30) Foreign Application Priority Data
May 9, 2007 (JP) 2007-124309

(51) Int. Cl. G06F 1/12

(52) U.S. Cl. 710/61

(57) ABSTRACT

The present invention relates to a technique to absorb a speed difference between a data transmission/reception unit, included in a host device which has a interface controller, and a data transmission/reception unit with a external device. The host device and the external apparatus are both electronic apparatus, and the interface controller outputs a transfer clock to the external apparatus, and controls the data transfer between the interface controller and the external apparatus, in accordance with a specific interface specification defined based on the transfer clock.

The entire disclosure of Japanese Patent Application No. 2007-124309, filed May 9, 2007 is expressly incorporated by reference herein.

### BACKGROUND

1. Technical Field

The present invention relates to a technique to absorb a speed difference between a data transmission/reception within blocks included in a host device which has the interface controller, and a data transmission/reception of the host device with an external device. Here, the host device and the external apparatus are both electronic apparatus, and this interface controller outputs a transfer clock to the external apparatus, and controls the data transfer between the interface controller and the external apparatus, in accordance with a specific interface specification defined based on the transfer clock. Examples of the external apparatus include: memory cards such as a multimedia card (MMC) and a secure digital (SD) card; a card type I/O apparatus (hereafter referred to as “SDI/O card”) compliant with the SDI/O specification which is based on the interface specification of the SD card; and a drive device such as an HDD compliant with the CE-ATA specification which is based on the MMC interface specification, which is hereafter referred to as a “CE-ATA drive device”.

2. Related Art

Access control of memory cards (external apparatus) such as MMCs and SD cards is normally carried out, in accordance with an interface specification of the respective memory card, by an interface controller which is provided in a host device that accesses the memory cards, so as to carry out reading/writing of data.

Hereafter, data transmitted/received through command lines may also be referred to as “command line data”, and data transmitted/received through data lines may also be referred to as “data line data”. According to the interface specifications of memory cards such as SD cards and MMCs, transmissions/receptions of the command line data and the data line data are carried out based on the transfer clock supplied from the interface controller to the memory card. The same applies for the SDI/O and CE-ATA interface specifications.

As described, the interface controller supplies the transfer clock to the electronic apparatus coupled to the interface controller, and this transfer clocks serves as a base in the operation of the electronic apparatus, so that the interface controller controls the operation of this apparatus.

JP-A-2004-192488 and JP-A-2006-178915 are examples of related art.

In order to increase the speed of data transfer, i.e. transmission/reception of data between an interface controller and an external apparatus, it is desirable to set the frequency of the transfer clock to the maximum frequency of the interface specification employed by that external apparatus (for instance, 50 MHz in case of high-speed mode of the SD card).

On the other hand, the interface controller may receive data sent from one block in the host device, so as to transmit the data to the external apparatus based on a clock used in that block. Hereafter, such data is referred to as “transmission target data”, and this clock is referred to as an “internal clock of the host device” for the convenience of description. The internal clock of the host device is also used when the interface controller transmits data received from the external apparatus to that block. Hereafter, such data is referred to as “received data”.

The internal clock of the host device serves as a base of the data transmission/reception between the block and the interface controller. Here, if a frequency ratio of the internal clock of the host device to the transfer clock is an integer, particularly, a power-of-two, the data transmission/reception based on the transfer clock is carried out in synchronization with the data transmission/reception based on the internal clock of the host device.

However, if, for instance, this block in the host device were a FIFO buffer of an USB controller, a clock that has a frequency of, for instance, 60 MHz could be used as the internal clock of the host device, i.e., the USB complies with the USB2.0 specification.

If the frequency of the internal clock of the host device is 60 MHz, and if the frequency of the transfer clock is 50 MHz, the frequency ratio does not become an integer. Therefore, the data transmission/reception based on the internal clock of the host device becomes asynchronous to the data transmission/reception based on the transfer clock.

If the frequency of the transfer clock is set to, for instance, 30 MHz, so that the frequency ratio becomes an integer (60/30=2), the problem of the transmission/reception being asynchronous is resolved. However, the data transmission speed with the external apparatus cannot be maximized.

This leads to a challenge that, in order to maximize the speed of data transmission/reception to and from the external apparatus, the frequency difference between the transfer clock and the internal clock of the host device needs to be absorbed, while enabling the data, received from the outside of the interface controller based on the internal clock of the host device, to be transmitted to the external apparatus at the transfer clock, and enabling the received data, transmitted from the external apparatus based on the transfer clock, to be transmitted to the outside of the interface controller based on the internal clock of the host device.

### SUMMARY

An advantage of the invention resolves the above challenge, and provides a technique which allows the interface controller to absorb the frequency difference between the transfer clock and the internal clock of the host device, while enabling the data, received from the outside of the interface controller based on the internal clock of the host device, to be transmitted to an external apparatus based on the transfer clock, and enabling the data, received from the external apparatus at the transfer clock, to be transmitted to the outside of the interface controller provided in the host device, based on the internal clock of the host device, so as to output the transfer clock to the external apparatus such as MMCs, SD cards, SDI/O cards, and CE-ATA drive devices.

According to an aspect of the invention, an interface controller includes: a data transfer unit operating based on a first clock; a data transmitter-receiver unit operating based on a second clock which has a frequency different from that of the first clock; and a bridge unit provided between the data transfer unit and the data transmitter-receiver unit, the bridge unit operating based on the first clock and the second clock. Here, the interface controller provided in a host device outputs the first clock to an external apparatus which is coupled with an exterior of the host device, so as to control data transfer between the host device and the external apparatus, in accordance with a specific interface specification defined based on the first clock. Moreover, the first clock and the second clock have a relationship in which a frequency of one clock having a higher frequency is not an integral multiple of a frequency of the other clock having a lower frequency. Further, if the data transmitter-receiver unit receives, from an outside of the interface controller, data to be transmitted to the external apparatus based on the second clock, then the data transmitter-receiver unit transmits data received from the outside of the interface controller based on the second clock, the bridge unit receives data transmitted from the data transmitter-receiver unit based on the second clock, so as to transmit received data to the data transfer unit based on the first clock, and the data transfer unit receives data transmitted from the bridge unit based on the first clock, so as to transmit the received data to the external apparatus base on the first clock. Still further, if the data transfer unit receives data transmitted from the external apparatus based on the first clock, then the data transfer unit transmits data received from the external apparatus to the bridge unit based on the first clock, the bridge unit receives data transmitted from the data transfer unit based on the first clock, so as to transmit the received data to the data transmitter-receiver unit based on the second clock, and the data transmitter-receiver unit receives the data transmitted from the bridge unit based on the second clock, and transmits the received data to the outside of the interface controller base on the second clock.

According to this interface controller, the frequency difference between the first clock and the second clock is absorbed, while enabling the data, received by the data transmitter-receiver unit from the outside of the interface controller based on the second clock, to be transmitted from the data transmitter-receiver unit to the external apparatus based on the first clock, and while enabling the data received based on the first clock from the external apparatus to be transmitted to the outside of the interface controller based on the second clock.

In this case, the bridge unit includes a data transmitter-receiver side buffer unit and a data transfer side buffer unit, and if the bridge unit receives data transmitted from the data transmitter-receiver unit, then the data transmitter-receiver side buffer unit receives and accumulates the data transmitted from the data transmitter-receiver unit based on the second clock, and the data transfer side buffer unit, based on the first clock, gets and accumulates data accumulated in the data transmitter-receiver side buffer unit, so as to transmit the data to the data transfer unit. Moreover, if the bridge unit receives data transmitted from the data transfer unit, then the data transfer side buffer unit receives and accumulates the data transmitted from the data transfer unit based on the first clock, and, the data transmitter-receiver side buffer unit, based on the second clock, gets and accumulates data accumulated in the data transfer side buffer unit, so as to transmit the data to the data transmitter-receiver unit.

This configuration of the bridge allows the bridge to carry out the following operations. If the bridge receives the data transmitted from the data transmitter-receiver unit, the data transmitted from the data transmitter-receiver unit is received based on the second clock, and this received data is transmitted to the data transfer unit based on the first clock. If the bridge receives the data transmitted from the data transfer unit, the reception is based on the first clock and the transmission of the received data to the data transmitter-receiver unit is based on the second clock.

It is preferable that the second clock have a frequency higher than that of the first clock. Moreover, it is preferable that, if the bridge unit receives data transmitted from the data transfer unit, then the following be satisfied. The data transfer side buffer unit sequentially accumulates the data transmitted from the data transfer unit based on the first clock in a unit of n bytes (n is an integer, n≧1), so as to output accumulated data to the data transmitter-receiver side buffer unit in a unit of 2n bytes, and the data transmitter-receiver side buffer unit sequentially accumulates, based on the second clock, the data output from the data transfer side buffer unit, so as to transmit accumulated data to the data transmitter-receiver unit in a unit of n bytes based on the second clock.

In the case where the bridge receives the data transmitted from the data transfer unit, the above configuration makes it easier for the bridge to transmit the data, sent from the data transfer unit at the first clock, to the data transmitter-receiver unit at the second clock, if the second clock has a higher frequency than that of the first clock.

It is preferable that, if a size of the data accumulated therein becomes equal to or greater than a threshold value set in advance, then the data transmitter-receiver side buffer unit carry out a cease instruction to discontinue accumulation of data in the data transfer side buffer unit, the data being transmitted from the data transfer unit, and, the data transfer side buffer unit instruct, corresponding to the cease instruction, the data transfer unit to cease receiving data from the external apparatus, so as to cease a transmission of data from the data transfer unit, in order to discontinue the accumulation of data.

This prevents the interface controller from receiving data from the external apparatus during the period in which the bridge cannot receive data transmitted from the external apparatus.

It is preferable that the second clock have a frequency higher than that of the first clock. Moreover, it is preferable that, if the bridge unit receives data transmitted from the data transmitter-receiver unit, then the following be satisfied. The data transmitter-receiver side buffer unit sequentially accumulates the data transmitted from the data transmitter-receiver unit based on the second clock in a unit of n bytes, so as to output the accumulated data to the data transfer side buffer unit in a unit of 4n bytes, and the data transfer side buffer unit accumulates, based on the first clock, the data output from the data transmitter-receiver side buffer unit, so as to transmit accumulated data to the data transfer unit in a unit of n bytes based on the first clock.

In the case where the bridge receives the data transmitted from the data transmitter-receiver unit and where the second clock has a higher frequency than that of the fast clock, the above configuration makes it easier for the bridge to transmit the data, sent from the data transmitter-receiver unit at the second clock, to the data transfer unit at the first clock.

The aspect of the invention may be realized, in addition to in the interface controller, in various forms such as an integrated circuit in which the interface controller is integrated therein.

### BRIEF DESCRIPTION OF THE DRAWINGS

The invention will be described with reference to the accompanying drawings, wherein like numbers reference like elements.

FIG. 1 is a block diagram illustrating a configuration of an interface controller as one embodiment of the invention.

FIG. 2 is an illustration showing functionalities of a FIFO side buffer unit and a control side buffer unit that are included in a bridge unit during a write operation.

FIG. 3 is an illustration showing functionalities of the FIFO side buffer unit and the control side buffer unit that are included in the bridge unit during a read operation.

### DESCRIPTION OF EXEMPLARY EMBODIMENTS

Embodiments of the invention will now be described in the following order.

### A. Overview of Interface Controller

### B. Bridge Unit Operation During the Write Operation

### C. Bridge Unit Operation During the Read Operation

### D. Effects

### E. Modifications

### A. Overview of Interface Controller

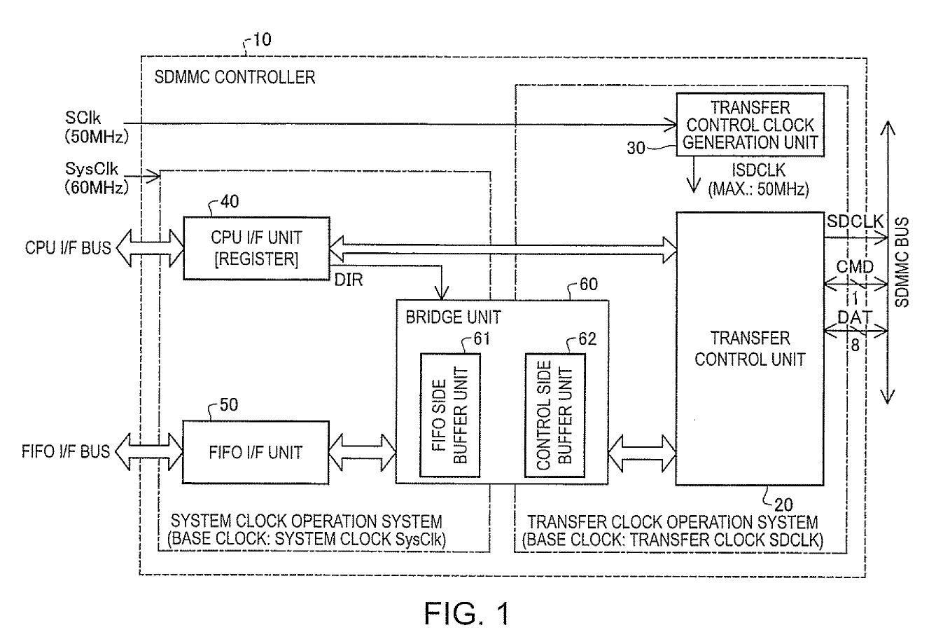

FIG. 1 is a block diagram illustrating a configuration of an interface controller as one embodiment of the invention. A secure digital multimedia card (SDMMC) controller 10 according to an embodiment is installed in an un-illustrated host device as an interface controller shown in FIG. 1, and carries out an access control of an un-illustrated memory card as an external apparatus, by controlling the transfer of commands and data between the host device and the memory card which is coupled with an SDMMC bus. The SDMMC bus supports the interfaces of both the SD card and the MMC card, and can be shared therebetween. The SD card and the MMC are examples of memory cards. The SD card or the MMC card is coupled as the memory card with the SDMMC bus.

The SDMMC controller 10 transmits a transfer clock SDCLK to the memory card through a clock line of the SDMMC bus. The SDMMC controller 10 also transmits/receives command data or response data to/from the memory card through a command line of the SDMMC bus. Further, it transmits/receives a group of data such as read data, write data, and status data to/from the memory card through eight data lines of the SDMMC bus. However, if the SD card is used as the memory card, the data lines defined for use are 1-bit and 4-bit data lines, and therefore the number of effective data lines changes among the 8 data lines used for 8 bits. Similarly, in the case of an MMC, the number of actually effective data lines also changes among the 8 data lines used for 8 bits, depending on which one of 1-bit, 4-bit, and 8-bit data lines defined for the MMC is used.

The command data and response data transmitted/received through the command line is collectively called “command line data CMD”, and signals containing the command line data may also be called as “command line data signals CMD”. The read data, write data, and status data transmitted/received through the data line is collectively called “data line data DAT”, and signals containing the data line data may also be called as “data line data signals DAT”. The signals containing the transfer clock transmitted through the clock line may also be called “transfer clock signals”.

The SDMMC controller 10 includes a transfer control unit 20, a transfer clock generation unit 30, a CPU I/F unit 40, a FIFO I/F unit 50, and a bridge unit 60. This SDMMC controller 10 is a semiconductor integrated circuit formed on a single semiconductor substrate.

The transfer control unit 20, the transfer clock generation unit 30, and a part of the bridge unit 60 are categorized as a transfer clock operation system that operates based on the transfer clock SDCLK generated in the transfer clock generation unit 30. On the other hand, CPU I/F unit 40, FIFO I/F unit 50, and the rest of the bridge unit 60 are categorized as a system clock operation system that operates based on a system clock SysClk. The system clock SysClk serves as a base of operation for an un-illustrated FIFO buffer in the host device, the FIFO buffer being coupled through a FIFO I/F bus. It also serves as a base for data transmission/reception executed between the FIFO buffer and the FIFO I/F unit 50 through the FIFO I/F bus. The FIFO buffer installed in the USB controller may be used as this un-illustrated FIFO buffer. The actual clocks used in each block of the transfer clock operation system are an internal clock (internal transfer clock ISDCLK described later) equivalent to the transfer clock and other various clocks which are in synchronization with this internal clock. This means that the operation of each block in the transfer clock operation system is based on the transfer clock SDCLK. The transfer clock SDCLK and the system clock SysClk respectively correspond to the first clock and the second clock according to the aspect of the invention.

For the convenience of description, the SD card that complies with a high-speed mode is used as the memory card coupled with the SDMMC bus in this embodiment, and a frequency Fc of the transfer clock SDCLK is 50 MHz, which is the maximum value defined for the interface specification of the SD card. A frequency Fsys of the system clock SysClk is 60 MHz, which is defined by the USB2.0.

The CPU I/F unit 40 stores the various units of control data such as the command data supplied from an un-illustrated CPU through a CPU I/F bus, in a register installed inside the CPU I/F unit 40. The various units of control data stored in the register is transferred to the transfer control unit 20 to be used. The CPU I/F unit 40 stores the various units of control data such as response data transferred from the transfer control unit 20, and transfers the data to the CPU.

The FIFO I/F unit 50 receives the write data supplied from the un-illustrated FIFO buffer through the FIFO I/F bus so as to be addressed to the memory card, and transfers the data to the bridge unit 60. The FIFO I/F unit 50 receives, from the bridge unit 60, the read data sent from the memory card, and transmits the data to the FIFO buffer through the FIFO I/F bus. The data transmission/reception is carried out through the FIFO I/F bus with a 32-bit (4-byte) data length, i.e. in 4-byte units. The data communication between the FIFO I/F unit 50 and the bridge unit 60 is carried out in an 8-bit (1-byte) data length, i.e. in 1-byte units. The FIFO I/F unit 50 corresponds to the data transmitter-receiver unit according to the aspect of the invention.

The bridge unit 60 includes a FIFO side buffer unit 61 that operates based on the system clock SysClk, and a control side buffer unit 62 that operates at the transfer clock SDCLK, or, in a strict definition, at the internal transfer clock ISDCLK. The FIFO side buffer unit 61 and the control side buffer unit 62 respectively correspond to the data transmitter-receiver side buffer unit and the data transfer side buffer unit according to the aspect of the invention. The FIFO side buffer unit 61 and the control side buffer unit 62 in the bridge unit 60 relay the transfer of data between the FIFO I/F unit 50 and the transfer control unit 20, the FIFO I/F unit 50 operating based on the system clock SysClk and the transfer control unit 20 operating based on the transfer clock SDCLK that has different frequency from that of the system clock SysClk. The further description of the bridge unit 60 will follow later.

The transfer control unit 20 transmits the internal transfer clock ISDCLK generated in the transfer clock generation unit 30 to the memory card as the transfer clock SDCLK, generates an output command data (command line data) addressed to the memory card out of the command data received from the CPU I/F unit 40, and transmits the output command data to the memory card based on the transfer clock SDCLK. The transfer control unit 20 sends the transfer clock SDCLK to the memory card, and transmits, based on the transfer clock SDCLK, the write data (data line data) received from the FIFO I/F unit 50 through the bridge unit 60.

The transfer control unit 20 receives the command line data signal received from the memory card through the SDMMC bus, and transfers the response data (command line data) included in the command line data signal to the CPU I/F unit 40. It also receives the data line data signal from the memory card through the SDMMC bus, and transfers the read data (data line data) included therein to the FIFO I/F unit 50 through the bridge unit 60. The data communication between the transfer control unit 20 and the bridge unit 60 is carried out with an 8-bit (1-byte) data length, i.e. in 1-byte units.

The transfer control unit 20 corresponds to the data transfer unit according to the aspect of the invention.

The transfer clock generation unit 30 generates the transfer clock SDCLK, based on a source clock SClk. The frequency of the source clock SClk corresponds to the maximum transfer speed of the memory card coupled with the interface controller. In this embodiment, the SD card is used as an example of the memory card, and therefore a clock used here has the frequency equal to the maximum transfer speed in the high-speed mode, i.e., a frequency Fs of 50 MHz. The frequency of the source clock SClk does not necessarily be equal to that of the transfer clock SDCLK, and may be different.

The feature of the SDMMC controller 10 as the interface controller according to the aspect of the invention is that the bridge unit 60 is provided between the FIFO I/F unit 50 and the transfer control unit 20, so as to relay the transfer of data between the FIFO I/F unit 50 which operates at the system clock SysClk and the transfer control unit 20 which operates at the transfer clock SDCLK. The operation of the bridge unit 60 is further described respectively for write-operation and read-operation.

### B. Bridge Unit Operation During the Write Operation

At the time of data write-in to the memory card, processing direction data DIR is supplied to the bridge unit 60. This processing direction data DIR is set corresponding to the write operation, and indicates the direction of data processing in the bridge unit 60. The bridge unit 60 operates the FIFO side buffer unit 61 and the control side buffer unit 62 in accordance with the processing direction data DIR supplied corresponding to the write operation.

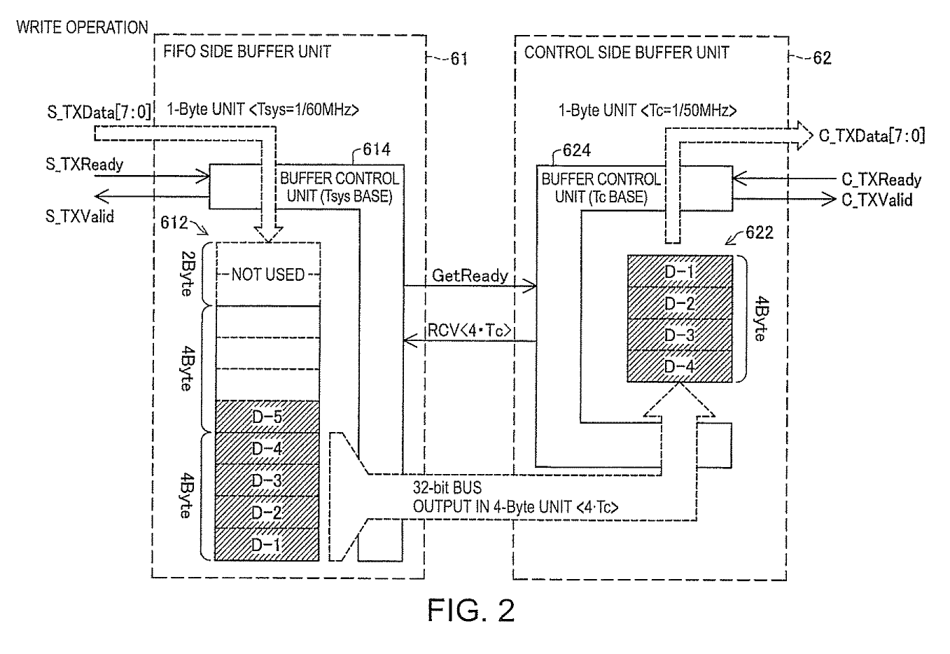

FIG. 2 is an illustration showing functionalities of the FIFO side buffer unit 61 and the control side buffer unit 62 that are included in the bridge unit 60 during the write operation.

During the write operation, the FIFO side buffer unit 61 receives and accumulates the pieces of write data sent from the FIFO I/F unit 50, while transferring the data to the control side buffer unit 62. The control side buffer unit 62 sends the write data received from the FIFO side buffer unit 61 to the transfer control unit 20, while accumulating that write data. The bridge unit 60 thereby relays the transfer of the write data from the FIFO I/F unit 50 to the transfer control unit 20.

The control side buffer unit 61 includes a FIFO side buffer 612 and a FIFO side buffer control unit 614 for controlling the operation of this FIFO side buffer 612.

The FIFO side buffer 612 has a 10-byte buffer region. However, during the write operation, the FIFO side buffer 612 uses only 8 bytes of this 10-byte buffer region, and the remaining 2 bytes are set as an unallocated region. The effective 8-byte buffer region is divided into two segments, each segment containing 4 bytes. At the time of read operation, the whole 10-byte buffer region is used, as will be described later.

The FIFO side buffer control unit 614 controls, based on a cycle Tsys (=1/Fsys) of the system clock SysClk that has the frequency Fsys of 60 MHz, the write data reception sent from the FIFO I/F unit 50, as well as the write data storage into the FIFO side buffer 612, followed by the data output addressed to the control side buffer unit 62.

The control side buffer unit 62 includes, similar to the FIFO side buffer 61, a control side buffer 622 and a control side buffer control unit 624 that controls the operation of this control side buffer 622.

The control side buffer 622 has a 4-byte buffer region, i.e. a buffer region that corresponds to one of the buffer segment of the FIFO side buffer 612.

The control side buffer control unit 624 controls, based on a cycle Tc (=1/Fc) of the transfer clock SDCLK, or, in a strict definition, an equivalent clock with the frequency Fc of 50 MHz, the capturing of write data output from the FIFO side buffer unit 61 and the storing of that write data into the control side buffer 622, as well as the data transmission to the transfer control unit 20.

During the write operation, the FIFO side buffer unit 61 and the control side buffer unit 62 operate as follows so as to relay the transfer of write data from the FIFO I/F unit 50 to the transfer control unit 20.

When send-ready S_TXReady is asserted from the FIFO I/F unit 50 to the FIFO side buffer control unit 614 of the FIFO side buffer unit 61, the FIFO side buffer control unit 614 asserts send-valid S_TXvalid to the FIFO I/F unit 50, based on the system clock SysClk.

When the send-ready S_TXReady is asserted to the FIFO side buffer control unit 614 from the FIFO I/F unit 50, the FIFO side buffer control unit 614 receives the write data S_TXData [7:0] which is sent out in 1-byte units, and accumulates the data in the FIFO side buffer 612.

The write data sent out in 1-byte units from the FIFO I/F unit 50 is refreshed in accordance with the change in the send valid S_Txvalid. If there are a several bytes of free space in the FIFO side buffer 612, the write data can be sequentially accumulated therein. Therefore, the send valid S_Txvalid changes in the cycle Tsys of the system clock SysClk. Therefore, the transmission of the write data from the FIFO I/F unit 50 is normally carried out in a sequence of 1-byte units in the cycle Tsys of the system clock SysClk. FIG. 2 indicates the state in which the 5 bytes of write data [D-1] through [D-5] are sequentially accumulated in 1-byte units.

The FIFO side buffer control unit 614 monitors the quantity of data accumulation in the FIFO side buffer 612, and when at least 4 bytes of write data are accumulated, it asserts get-ready GetReady to the control side buffer control unit 624, and outputs the first 4 bytes of write data collectively to the control side buffer unit 62 in the order of accumulation. However, even if the write data accumulated in the FIFO side buffer 612 is less than 4 bytes since these 4 bytes are the fraction of the entire length of the write data, the FIFO side buffer control unit 614 outputs this data to the control side buffer unit 62.

The control side buffer control unit 624 in the control side buffer unit 62 outputs a get notification RCV that changes every time it receives the 4-byte write data output from the FIFO side buffer unit 61, and accumulates the received write data in the control side buffer 622.

The FIFO side buffer control unit 614 refreshes the write data to be read out from the FIFO side buffer 612 so as to be output from the FIFO side buffer unit 61 to the control side buffer unit 62, based on the change timing of the get notification RCV output from the control side buffer unit 62. Specifically, the refreshing is executed based on the change timing detected by synchronizing the change of the retrieval notification RCV with the system clock SysClk.

After accumulating the write data output from the FIFO side buffer unit 61 in the control side buffer 622 in 4-byte units, the control side buffer control unit 624 in the control side buffer unit 62 asserts send-ready C_TXReady and outputs the accumulated write data as transmission data C_TXData [7:0] in 1-byte units, into the transfer control unit 20. FIG. 2 indicates the state in which the 4 bytes of write data pieces [D-1] through [D-4] that are accumulated in sequence in the FIFO side buffer 612 are now accumulated in the control side buffer 622 in 4-byte units. The output of this write data to the transfer control unit 20 is carried out in the sequence of [D-1], [D-2], [D-3], [D-4], . . . and so on.

When the send valid C_TXValid which indicates that the write data is received by the transfer control unit 20 is asserted, the control side buffer control unit 624 refreshes the write data which is to be output as the transmission data C_TXData [7:0] to the next data. The control side buffer control unit 624 thereby sequentially transmits the write data to the transfer control unit 20. Normally, the transmission data C_TXData [7:0] is transmitted to the transfer control unit 20 in the cycle Tc of the transfer clock SDCLK, in the state in which the send-ready C_TXReady is asserted and the send valid C_TXValid is supplied, changing in the cycle Tc of the transfer clock SDCLK.

The control side buffer control unit 624 changes the get notification RCV in the event that the control side buffer 622 outputs the fourth byte of the write data accumulated in the control side buffer 622 in 4-byte units as a transmission data C_TXData [7:0]. At this time, as described, the control side buffer unit 624 receives the write data that is already output from the FIFO side buffer unit 61, and accumulates it in the control side buffer 622. Moreover, as described, the write data to be output by the FIFO side buffer unit 61 is refreshed into the subsequent 4-byte data and is output therefrom. This write data is accumulated in the control side buffer 622 at the time of subsequent change in the retrieval notification RCV.

When the write operations are carried out in sequence, the get notification RCV becomes a toggle signal that inverts with a time interval, between inversions, that is four times as long as the cycle Tc of the transfer clock SDCLK, and thus the transfer of the write data from the FIFO side buffer unit 61 to the control side buffer unit 62 is carried out in the interval four times as long as the cycle Tc of the transfer clock SDCLK.

Moreover, the FIFO side buffer unit 61 operates based on the system clock SysClk with the frequency Fsys of 60 MHz, and the control side buffer unit 62 operates based on the transfer clock SDCLK with the frequency Fc of 50 MHz which is smaller than that of the system clock SysClk. Therefore, the FIFO side buffer 612 in the FIFO side buffer unit 61 basically operates, during the write operation, in a full state or a state close to the full state. If the FIFO side buffer 612 is in the full state, the FIFO side buffer control unit 614 negates the send valid S_Txvalid, and stops the write data transmission from the FIFO I/F unit 50, so as to make the state control of the FIFO side buffer 612 easier.

As described, the FIFO side buffer unit 61 sequentially accumulates the write data transmitted from the FIFO I/F unit 50 in 1-byte units, based on the system clock SysClk. It then outputs the accumulated write data to the control side buffer unit 62 in 4-byte units. The control side buffer unit 62 accumulates the write data output from the FIFO side buffer unit 61 in 4-byte units, so as to sequentially transfer the accumulated 4 bytes write data to the transfer control unit 20 by 1-byte units, based on the transfer clock SDCLK. That is to say that in a normal state, the transmission of the write data to the transfer control unit 20 is sequentially carried out in 1-byte units in the cycle Tc of the transfer clock SDCLK.

The accumulation of the write data is carried out in 4-byte units, every time the previously accumulated 4-byte write data is transmitted to the transfer control unit 20. Here, the write data being accumulated in the control side buffer unit 62 is output from the FIFO side buffer unit 61. Therefore, the write data is output from the FIFO side buffer unit 61 in 4-byte units, in accordance with the transmission of the previously accumulated 4-byte write data to the transfer control unit 20.

As described, since the transmission of write data to the transfer control unit 20 is normally carried out in sequence in 1-byte units in the cycle Tc of the transfer clock SDCLK, the write data needs to be output from the FIFO side buffer unit 61 in 4-byte units in a cycle four times as long as the cycle Tc of the transfer clock SDCLK. This means that a cycle (80 ns) four times as much as the cycle Tc (20 ns) of the transfer clock SDCLK is longer than the time (approximately 66.7 ns) the 4-byte write data takes to be accumulated on the FIFO side buffer 612 in the cycle Tsys (approximately 16.7 ns) of the system clock SysClk.

Moreover, during the write operation in the bridge unit 60, while the write data is received from the FIFO I/F unit 50 based on the system clock SysClk with the frequency Fsys of 60 MHz in 1-byte units, the write data is transmitted to the transfer control unit 20 based on the transfer clock with the frequency Fc of 50 MHz that is asynchronous to the system clock SysClk.

Functionality is required to the SDMMC controller, so that the write-in of the write data to the memory card is not aborted by a reason originated from of the operation of the SDMMC controller. The SDMMC controller 10 according to this embodiment satisfies the above requirement in the following manner.

In a state in which at least 4 bytes of write data are accumulated in the FIFO side buffer 612 of the FIFO side buffer unit 61, in other words, in a state in which the write data is ready to be output to the control side buffer unit 62, the assertion of the get-ready GetReady by the FIFO side buffer control unit 614 to the control side buffer unit 62 causes the control side buffer control unit 624 to assert the send-ready C_TXReady to the transfer control unit 20, followed by the transfer control unit 20 supplying the transfer clock to the memory card. Consequently, the write-in of the write data to the memory card is carried out.

In a state in which less than 4 bytes of write data are accumulated in the FIFO side buffer 612, or, in a state in which the write data accumulation has ended, in other words, in a state in which the write data cannot be output to the control side buffer unit 62, the negation of the get-ready GetReady by the FIFO side buffer control unit 614 to the control side buffer unit 62 causes the control side buffer control unit 624 to negate the send-ready C_TXReady to the transfer control unit 20, followed by the transfer control unit 20 discontinuing the supply of the transfer clock to the memory card. Consequently, the write-in of the write data to the memory card is aborted or stopped. However, even if the write data accumulated in the FIFO side buffer 612 is less than 4 bytes, the FIFO side buffer control unit 614 outputs this write data block which is less than 4-byte long to the control side buffer unit 62, if it is the last block of the write data after the write data accumulation has ended, and negates the get-ready GetReady after the write data is accumulated in the control side buffer 622 of the control side buffer unit 62.

Therefore, in the state in which the write data is supplied from the FIFO buffer to the bridge unit 60 and in which the write data to be written-in to memory card is accumulated in the FIFO side buffer 612, the bridge unit 60 outputs the accumulated write data to the transfer control unit 20. Thus, the bridge unit 60 does not cause the write-in of the write data to the memory card to stop, and the operation of the SDMMC controller does not abort the write-in of the write data to the memory card.

### C. Bridge Unit Operation During the Read Operation

At the time of the data read-out from the memory card, the processing direction data DIR is supplied to the bridge unit 60. This processing direction data DIR is set corresponding to the read operation of the CPU I/F unit 40. The bridge unit 60 operates the FIFO side buffer unit 61 and the control side buffer unit 62 in accordance with the processing direction data DIR supplied corresponding to the read operation.

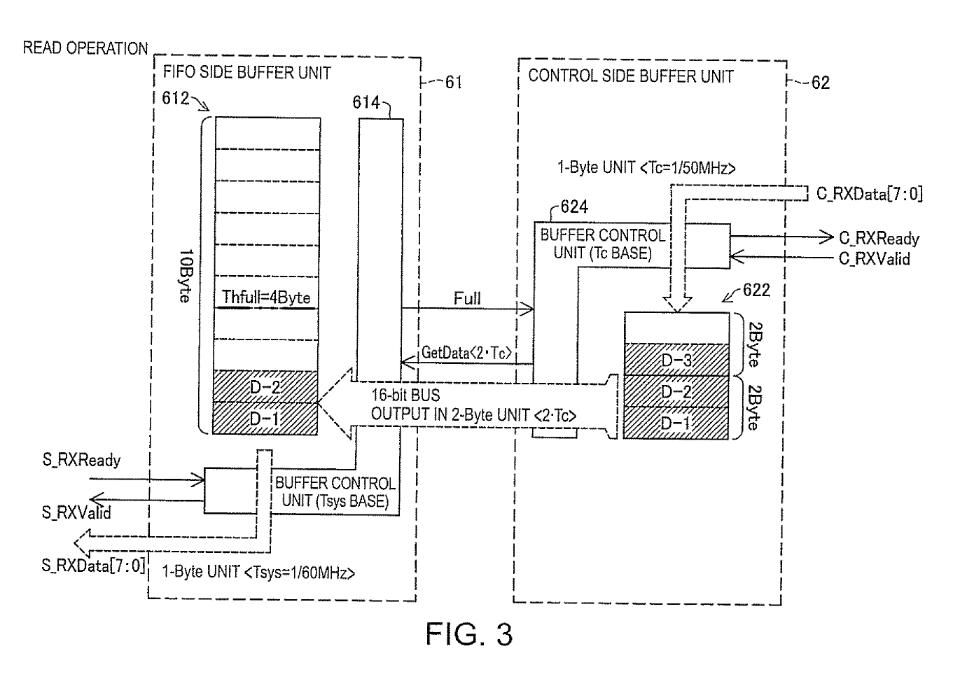

FIG. 3 is an illustration showing functionalities of the FIFO side buffer unit 61 and the control side buffer unit 62 that are included in the bridge unit 60 during the read operation.

During the read operation, the control side buffer unit 62 receives and accumulates the pieces of read data sent from the transfer control unit 20, while transferring the data to the FIFO side buffer unit 61. The FIFO side buffer unit 61 transmits the read data to the FIFO I/F unit 50, while accumulating, in the FIFO side buffer unit 61, the read data transferred from the control side buffer unit 62. The bridge unit 60 thereby relays the transfer of the read data, from the transfer control unit 20 to the FIFO I/F unit 50.

Similar to the structure in the write operation, a structure in the read operation includes the FIFO side buffer unit 61 and the controller side buffer unit 62, the FIFO side buffer unit 61 having the FIFO side buffer 612 and the FIFO side buffer control unit 614 that controls the operation of this FIFO side buffer 612, and the control side buffer unit 62 having the control side buffer 622 and the control side buffer control unit 624 that controls the operation of this control side buffer 622.

Unlike the write operation, a 4-byte buffer region of the control side buffer 622 in the control side buffer unit 62 is segmented into two regions, each region containing 2 bytes. Moreover, unlike the write operation, the control side buffer control unit 624 controls the reception of the read data transmitted from the transfer control unit 20, and the read data storage in the control side buffer 622, as well as the data output addressed to the FIFO side buffer unit 61.

Further, unlike during the write operation, the entire 10-byte buffer region of the FIFO side buffer 612 in the FIFO side buffer unit 61 is used as an effective region, without including an unallocated 2-byte region, nor segmenting the effective region into two regions each having 4 bytes. The FIFO side buffer control unit 614 controls the reception of read data output from the control side buffer unit 62, and the read data storage in the FIFO side buffer 612, as well as the data transmission addressed to the FIFO I/F unit 50.

In the read operation, the FIFO side buffer unit 61 and the control side buffer unit 62 operate as follows, so as to relay the transfer of the read data from the transfer control unit 20 to the FIFO I/F unit 50.

The control side buffer control unit 624 of the control side buffer unit 62 asserts receive-ready C_RXReady to the transfer control unit 20, if the control side buffer 622 is not full, so as to allow the read data accumulation. When receive-valid C_RXValid is asserted from the transfer control unit 20 based on the transfer clock SDCLK, the control side buffer control unit 624 receives read-data C_RXData [7:0] sent out from the transfer control unit 20 in 1-byte units. FIG. 3 indicates the state in which the 3 bytes of read data pieces [D-1] through [D-3] are accumulated in the control side buffer 622.

In the status in which the receive-ready C_RXReady is asserted, the change in the read data sent out from the transfer control unit 20 in 1-byte units is governed by the transfer clock SDCLK, specifically, the receive-valid C_RXValid which changes in the cycle Tc of the transfer clock SDCLK.

If at least 2 bytes of read data are accumulated in the control side buffer 622, the control side buffer control unit 624 outputs get command GetData, and collectively outputs the first 2 bytes of write data to the FIFO side buffer unit 61, in the order in which each data piece is accumulated. This get command GetData is a toggle signal that repeats to inverse in a cycle twice as long as the cycle Tc of the transfer clock SDCLK, changing every time the 2-byte data is received from the transfer control unit 20 and is accumulated to the control side buffer 622. The read data being output is refreshed in synchronization with the change in this get command GetData. However, even if less than 2 bytes of the read data are accumulated in the control side buffer 622, control side buffer control unit 624 outputs this data block to the FIFO side buffer unit 61, if it is the last part of the entire read data that has a fraction of less than 2 bytes.

The FIFO side buffer control unit 614 of the FIFO side buffer unit 61 detects the change in the get command GetData output from the control side buffer unit 62 in synchronization with the system clock SysClk, and receives the read data output in 2-byte units from the control side buffer unit 62 at the detected change timing, so as to accumulate the data to the FIFO side buffer 612.

Here, by setting the read data transmitted from the control side buffer unit 62 to the FIFO side buffer unit 61 to be output in 2-byte units, the interval of change in the get command GetData is set to be twice as long (40 ns) as the cycle Tc of the transfer clock SDCLK. Since this interval is at least twice as long as the cycle Tsys (16.7 ns) of the system clock SysClk, the change in the get command GetData can be detected in synchronization with the system clock SysClk. The difference in frequencies between the transfer clock SDCLK and the system clock SysClk is thereby absorbed.

If receive-ready S_RXReady is asserted from the FIFO I/F unit 50 in a state in which the read data is accumulated in the FIFO side buffer 612, the FIFO side buffer control unit 614 asserts back receive-valid S_RXValid and outputs the read data accumulated in the FIFO side buffer 612 as received data S_RXData [7:0] in 1-byte units. FIG. 3 indicates the state in which the FIFO side buffer 612 includes the 2 bytes of accumulated read data, i.e the first two data pieces [D-1] and [D-2] accumulated in the control side buffer 622. The output of data to the FIFO I/F unit 50 is carried out in the sequence of [D-1], [D-2], . . . and so on.

Normally, the assertion of the receive-valid S_RXValid is repeated based on the system clock SysClk, specifically, in the cycle Tsys of the system clock SysClk, as long as the receive-ready S_RXReady is continuously asserted. The read data transmission from the FIFO side buffer unit 61 to the FIFO I/F unit 50 is therefore repeated in the cycle Tsys of the system clock SysClk.

If the FIFO I/F unit 50 cannot receive read data, the receive-ready S_RXReady is negated, and only the accumulation of read data output from the control side buffer unit 62 is repeated in the FIFO side buffer unit 61, and there is no output to the FIFO I/F unit 50.

The FIFO side buffer control unit 614 asserts full-state notification Full to the control side buffer control unit 624 of the control side buffer unit 62, if the quantity of read data accumulated in the FIFO side buffer 612 exceeds a predefined threshold Thfull. In response, the control side buffer control unit 624 negates the receive-ready C_RXReady to the transfer control unit 20. At this time, the transfer control unit 20 stops sending the transfer clock SDCLK to the memory card, as well as reading out the data therefrom. The control side buffer control unit 624 thereby stops the read data to be sent from the transfer control unit 20. As a result, the output of read data from the control side buffer unit 62 to the FIFO side buffer unit 61 stops.

The threshold Thfull is set in consideration of the following. If the receive-ready C_RXReady is negated, 4 bytes of read data, for instance, are accumulated in the control side buffer 622. Then, the 2 bytes of read data are output to the FIFO side buffer unit 61, and another block of approximately 2 bytes of read data are received. Consequently, after the assertion of the full-state notification Full, 6 bytes of read data may be output from the control side buffer unit 62 to the FIFO side buffer unit 61, due to issues such as time rag. Therefore, it is necessary to allocate a region as a margin, where the region corresponds to the output, from the control side buffer unit 62, of read data caused by the time lag. For instance, if the size of the buffer region is 10 bytes, the margin becomes 6-byte long and the threshold Thfull becomes 4-byte long.

As described, in the read operation, the bridge unit 60 sends out the read data transmitted from the transfer control unit 20 in 1-byte units at the transfer clock SD CLK in the frequency Fc (50 MHz), to the FIFO I/F unit 50 at the system clock SysClk with the frequency Fsys (60 MHz) which is asynchronous to the system clock SysClk.

Functionality is required to the SDMMC controller, so that the read-out of the read data from the memory card is not aborted by a reason originated from the operation of the SDMMC controller. The SDMMC controller 10 according to this embodiment satisfies the above requirement in the following manner.

The FIFO side buffer unit 61 operates based on the system clock SysClk that has a frequency higher than that of the transfer clock SDCLK. Therefore, the FIFO side buffer 612 does not basically become a full state during the transmission of read data to the FIFO side buffer unit 61. The full state may occur when the transmission of read data to the FIFO side buffer unit 61 is stopped.

Therefore, the read-out from the memory card continues even if the transmission of the transfer clock SDCLK from the transfer control unit 20 is discontinued due to a reason originated from the bridge unit 60, allowing the read-out of the read data from the memory not to be aborted because of the operation of the SDMMC controller.

### D. Effects

The SDMMC controller 10 as the interface controller according to the aspect of the invention includes the bridge unit 60 that operates in a manner described above, the bridge unit 60 being provided between the FIFO I/F unit 50 and the transfer control unit 20. In the host device, the write data is transmitted to the memory card based on the transfer clock SDCLK, while the write data is received based on the system clock SysClk with the frequency Fsys of 60 MHz. The transfer clock SDCLK is a clock asynchronous to the system clock SysClk, and is generated based on the source clock SClk (another clock different from the system clock SysClk) with the frequency Fs of 50 MHz, so that the transfer clock SDCLK has the frequency Fc of 50 MHz, which is different from that of the system clock SysClk. Moreover, the SDMMC controller 10 transmits, at the system clock SysClk, the read data transmitted from the memory card at the transfer clock SDCLK, to another block within the host device.

In a simple structure, an SDMC controller of the host device may include a bridge unit between a FIFO I/F unit and a FIFO buffer, and the SDMMC controller may operate based on a transfer clock. However, the FIFO buffer coupled with the SDMMC controller through the FIFOI/F bus may be, for instance, the FIFO buffer of the USB controller as described in the above embodiment. The data size of an internal data processing is not fixed in the FIFO buffer of the USB controller, and may have various sizes such as 1 byte, 2 bytes, 4 bytes, and 7 bytes, while the output data size is fixed to 4 bytes. Consequently, it is very difficult for the bridge unit to accurately manage the 4-byte data output from the FIFO buffer, so as to accommodate the various sizes in data processing unit, if the bridge unit is provided between the FIFO I/F unit and the FIFO buffer of the SDMMC controller.

On the other hand, no such problem occurs in the SDMMC controller 10 according to the aspect of the invention, since the bridge unit 60 is provided between the FIFO I/F unit 50 and the transfer control unit 20, and the bridge unit 60 transmits/receives data to and from the FIFO I/F unit 50 and the transfer control unit 20.

There is no abortion of data transmission/reception by a reason originated from the operation of the bridge unit 60 in the SDMMC controller 10, when writing in the write data and reading out the read data to and from the memory card.

### E. Modifications

The invention shall not be limited to the embodiment described above, and it is intended that, within the main scope of the invention, the aspect of the invention may be embodied with various modifications.

While the above description uses an SD card as an example of the memory card in the above description, this description may also apply to an MMC. Similarly, the same description applies to other external apparatuses such as SD-IO cards and CE-ATA drives which have interfaces complying with the interface specification of SD cards and MMCs.

The above description is based on the transfer clock SDCLK which is a clock asynchronous to the system clock SysClk. The transfer clock SDCLK is generated based on the source clock SClk with the frequency Fs of 50 MHz (another clock different from the system clock SysClk), so that the frequency Fc of the transfer clock SDCLK becomes, for instance, 50 MHz, which is different from that of the system clock SysClk. However, the description is applied not only to the case of 50 MHz, but also to the cases in which the frequency Fc of the transfer clock SD CLK is the one defined by the specification of the MMC, such as 52 MHz or 26 MHz. Similarly, the frequency Fsys of the system clock SysClk may also have various frequencies. In other words, the above description applies to various cases in which the transfer clock has a clock with a frequency determined by the specification of the interface of the external apparatus, and the system clock has a clock with a frequency different from that of the transfer clock, while the transfer clock and the system clock has a relationship in which the frequency of the clock with a higher frequency is not an integral multiple of the frequency of the other clock with a lower frequency. This relationship of frequency between the transfer clock and the system clock means that they have different frequencies, and that they are mutually asynchronous.

In the above description, 10 bytes and 4 bytes are the sizes of the buffer regions in the FIFO side buffer 612 and in the control side buffer 622. However, the sizes are not limited thereto, and may have various sizes.

In the above description, during the read operation, the control side buffer unit 62 sequentially accumulates the read data received from the transfer control unit 20 in 1-byte units in the control side buffer 622, and outputs the data to the FIFO side buffer unit 61 in 2-byte units. Moreover, the FIFO side buffer unit 61 sequentially accumulates the read data output from the control side buffer unit 62 in 2-byte units, and transmits the data to the FIFO I/F unit 50 in 1-byte units. However, the number of bytes is not limited thereto, and may be as follows. The control side buffer unit 62 may sequentially accumulate the read data received from the transfer control unit 20 in n-byte units (where “n” is an integer) in the control side buffer 622, and may output the data to the FIFO side buffer unit 61 in 2n-byte units. The FIFO side buffer unit 61 may accumulate the read data in 2n-byte units and transmit the data to the FIFO I/F unit 50 in n-byte units.

In the above description, during the write operation, the FIFO side buffer unit 61 sequentially accumulates the write data received from FIFO I/F unit 50 in 1-byte units in the FIFO side buffer 612, and outputs the data to the control side buffer unit 62 in 4-byte units. Moreover, the control side buffer unit 62 sequentially accumulates the write data output from the FIFO side buffer unit 61 in 4-byte units, and sequentially transmits the data to the transfer control unit 20 in 1-byte units. However, the number of bytes is not limited thereto, and may be as follows. The FIFO side buffer unit 61 may sequentially accumulate the write data received from the FIFO I/F unit 50 in n-byte units in the FIFO side buffer 612, and may output the data to the control side buffer unit 62 in 4n-byte units. Moreover, the control side buffer unit 62 may sequentially accumulate the write data output from the FIFO side buffer unit 61 in 4n-byte units, and sequentially transmit the data to the transfer control unit 20 in n-byte units.

In the above description, “2” is the number of bytes the control side buffer unit 62 outputs the read data to the FIFO side buffer unit 61 every time during the read operation, while a plurality of bytes equal to or greater than 2 bytes may also be output. Similarly, in the above description, “4” is the number of bytes the FIFO side buffer unit 61 outputs the write data to the control side buffer unit 62 every time during the write operation, while a plurality of bytes equal to or greater than 4 bytes may also be output.

What is claimed is:

1. An interface controller, comprising:
a data transfer unit operating based on a first clock;
a data transmitter-receiver unit operating based on a second clock which has a frequency different from that of the first clock; and
a bridge unit provided between the data transfer unit and the data transmitter-receiver unit, the bridge unit operating based on the first clock and the second clock,
wherein the interface controller provided in a host device outputs the first clock to an external apparatus which is coupled with an exterior of the host device, so as to control data transfer between the host device and the external apparatus, in accordance with a specific interface specification defined based on the first clock;
wherein the first clock and the second clock have a relationship in which a frequency of one clock having a higher frequency is not an integral multiple of a frequency of the other clock having a lower frequency; and
wherein if the data transmitter-receiver unit receives, from an outside of the interface controller, data to be transmitted to the external apparatus based on the second clock, then:
the data transmitter-receiver unit transmits data received from the outside of the interface controller based on the second clock,
the bridge unit receives data transmitted from the data transmitter-receiver unit based on the second clock, so as to transmit received data to the data transfer unit based on the first clock, and
the data transfer unit receives data transmitted from the bridge unit based on the first clock, so as to transmit the received data to the external apparatus base on the first clock; and
wherein if the data transfer unit receives data transmitted from the external apparatus based on the first clock, then:
the data transfer unit transmits data received from the external apparatus to the bridge unit based on the first clock,
the bridge unit receives data transmitted from the data transfer unit based on the first clock, so as to transmit the received data to the data transmitter-receiver unit based on the second clock, and
the data transmitter-receiver unit receives the data transmitted from the bridge unit based on the second clock, and transmits the received data to the outside of the interface controller base on the second clock.

2. The interface controller according to claim 1, wherein the bridge unit includes a data transmitter-receiver side buffer unit and a data transfer side buffer unit, and wherein if the bridge unit receives data transmitted from the data transmitter-receiver unit, then:
the data transmitter-receiver side buffer unit receives and accumulates the data transmitted from the data transmitter-receiver unit based on the second clock, and
the data transfer side buffer unit, based on the first clock, gets and accumulates data accumulated in the data transmitter-receiver side buffer unit, so as to transmit the data to the data transfer unit, and wherein if the bridge unit receives data transmitted from the data transfer unit, then:
the data transfer side buffer unit receives and accumulates the data transmitted from the data transfer unit based on the first clock, and
the data transmitter-receiver side buffer unit, based on the second clock, gets and accumulates data accumulated in the data transfer side buffer unit, so as to transmit the data to the data transmitter-receiver unit.

3. The interface controller according to claim 2, wherein the second clock has a frequency higher than that of the first clock, and if the bridge unit receives data transmitted from the data transfer unit, then:
the data transfer side buffer unit sequentially accumulates the data transmitted from the data transfer unit based on the first clock in a unit of n bytes, where n is an integer equal to or greater than 1, so as to output accumulated data to the data transmitter-receiver side buffer unit in a unit of 2n bytes, and
the data transmitter-receiver side buffer unit sequentially accumulates, based on the second clock, the data output from the data transfer side buffer unit, so as to transmit accumulated data to the data transmitter-receiver unit in a unit of n bytes based on the second clock.

4. The interface controller according to claim 3, wherein if a size of the data accumulated therein becomes equal to or greater than a threshold value set in advance, then the data transmitter-receiver side buffer unit carries out a cease instruction to discontinue accumulation of data in the data transfer side buffer unit, the data being transmitted from the data transfer unit, and the data transfer side buffer unit instructs, corresponding to the cease instruction, the data transfer unit to cease receiving data from the external apparatus, so as to cease a transmission of data from the data transfer unit, in order to discontinue the accumulation of data.

5. The interface controller according to claim 2, wherein the second clock has a frequency higher than that of the first clock, and if the bridge unit receives data transmitted from the data transmitter-receiver unit, then:
the data transmitter-receiver side buffer unit sequentially accumulates the data transmitted from the data transmitter-receiver unit based on the second clock in a unit of n bytes, so as to output the accumulated data to the data transfer side buffer unit in a unit of 4n bytes, and
the data transfer side buffer unit accumulates, based on the first clock, the data output from the data transmitter-receiver side buffer unit, so as to transmit accumulated data to the data transfer unit in a unit of n bytes based on the first clock.

6. The interface controller according to claim 1, wherein the interface controller is an integrated circuit integrated on a semiconductor substrate.

7. An interface controller coupled between a first bus and a second bus, comprising:
a first data transfer circuit that transmit data between the first bus in synchronism with a first clock signal; and
a second data transfer circuit that transmit data between the second bus in synchronism with a second clock signal,
a frequency of the second clock signal is greater than a frequency of the first clock signal,
the frequency of the second clock signal is not an integral multiple of the first clock signal.

8. The interface controller according to claim 7, further comprising a bridge circuit coupled between the first data transfer circuit and the second data transfer circuits.

9. The interface controller according to claim 8,
the first data transfer circuit transmitting data to the bridge circuit in synchronism with the first clock signal, and
the second data transfer circuit receiving the data from the bridge circuit in synchronism with the second clock signal.

10. The interface controller according to claim 8,
the second data transfer circuit transmitting data to the bridge circuit in synchronism with the second clock signal, and
the first data transfer circuit receiving the data from the bridge circuit in synchronism with the first clock signal.

11. The interface controller according to claim 8,
the bridge circuit including a first buffer coupled with the first data transfer circuit and a second buffer coupled with the second data transfer circuit, and
the first buffer transmitting and receiving data between the first data transfer circuit in synchronism with the first clock signal, and
the second buffer transmitting and receiving data between the second data transfer circuit in synchronism with the second clock signal.

12. The interface controller according to claim 11,
a capacity of the second buffer being greater than a capacity of the first buffer.

13. The interface controller according to claim 11,
amount of data that is transmitted from the second buffer to the first buffer in a single transfer operation being greater than amount of data that is transmitted from the first buffer to the second buffer in a single transfer operation.

14. The interface controller according to claim 11,
amount of data that is transmitted from the second buffer to the first buffer in a single transfer operation being an integral multiple of amount of data that is transmitted from the first buffer to the second buffer in a single transfer operation.

15. The interface controller according to claim 11,
amount of data that is transferred between the first buffer and the second buffer being greater than amount of data that is transferred between the first buffer and the first data transfer circuit and amount of data that is transferred between the second buffer and the second data transfer circuit.
